(19) United States
(12) Patent Application Publication
(10) Pub. No.: US 2020/0182783 A1
(43) Pub. Date: Jun. 11, 2020

(54) MEASURING APPARATUS AND SUBSTRATE ANALYSIS METHOD USING THE SAME

(71) Applicant: SAMSUNG ELECTRONICS CO., LTD., Suwon-si (KR)

(72) Inventors: Sunhong JUN, Suwon-si (KR); Sung Yoon RYU, Suwon-si (KR); Souk KIM, Seoul (KR); Younghoon SOHN, Incheon (KR); Yusin YANG, Seoul (KR)

(21) Appl. No.: 16/566,100

(22) Filed: Sep. 10, 2019

(30) Foreign Application Priority Data
Dec. 7, 2018 (KR) 10-2018-0156544

(51) Int. Cl. G01N 21/3581; G01N 21/39; G02F 1/13363

(52) U.S. Cl. CPC G01N 21/3581; G01N 21/39; G02F 2001/133638; G01N 2021/393; G02F 2203/13; G02F 1/13363

(57) ABSTRACT

Disclosed are a measuring apparatus and a substrate analysis method using the same. The measuring apparatus includes a light source that generates a laser beam, a beam splitter that splits the laser beam into a probe laser beam and a reference laser beam, an antenna that receives the probe laser beam to produce a terahertz beam, an electro-optical device that receives the reference laser beam and the terahertz beam to change a vertical polarization component and a horizontal polarization component of the reference laser beam, based on intensity of the terahertz beam, and a streak camera that obtains a time-domain signal corresponding to a ratio between the vertical polarization component and the horizontal polarization component.

### CROSS-REFERENCE TO RELATED APPLICATION

Korean Patent Application No. 10-2018-0156544, filed on Dec. 7, 2018, in the Korean Intellectual Property Office, and entitled: “Measuring Apparatus and Substrate Analysis Method Using the Same,” is incorporated by reference herein in its entirety.

### BACKGROUND

### Field

Embodiments relate to a measuring apparatus and analysis method for semiconductor devices, and more particularly, to a measuring apparatus that measures a substrate resistance in a non-contact manner and a substrate analysis method using the same.

### 2. Description of the Related Art

As semiconductor devices become denser and more complicated, inspection of defects in semiconductor devices becomes more important. The inspection of defects on semiconductor devices may improve reliability and increase process yield. An optical method may be used to inspect defects on the semiconductor device.

### SUMMARY

According to some example embodiments, a measuring apparatus may include: a light source that generates a laser beam; a beam splitter that splits the laser beam into a probe laser beam and a reference laser beam; an antenna that receives the probe laser beam to produce a terahertz beam; an electro-optical device that receives the reference laser beam and the terahertz beam to change a vertical polarization component and a horizontal polarization component of the reference laser beam based on the terahertz beam; and a streak camera that obtains a time-domain signal corresponding to a ratio between the vertical polarization component and the horizontal polarization component.

According to some example embodiments, a measuring apparatus may include: a light source that generates a laser beam having a first pulse; a beam splitter that splits the laser beam into a probe laser beam and a reference laser beam; an antenna that receives the probe laser beam to produce a terahertz beam and provides a target object with the terahertz beam to generate a second pulse different from the first pulse; a pulse stretcher that stretches a width of the first pulse of the reference laser beam; a wave plate that receives the reference laser beam to create a vertical polarization component and a horizontal polarization component of the reference laser beam; an electro-optical device that receives the reference laser beam and the terahertz beam to change a pulse of the vertical polarization component and a pulse of the horizontal polarization component, based on the second pulse of the terahertz beam; and a streak camera that detects the vertical polarization and the horizontal polarization to obtain a time-domain signal corresponding to a ratio between the pulse of the vertical polarization component and the pulse of the horizontal polarization component.

According to some example embodiments, a substrate analysis method may include: obtaining a time-domain signal using a terahertz beam transmitted from a substrate and a femtosecond laser beam that temporally and spatially overlaps the terahertz beam; performing a Fourier transform on the time-domain signal to calculate real and imaginary spectra; analyzing the real and imaginary spectra to obtain first to n^{th} real and imaginary spectra of first to n^{th} layers included in the substrate; and using the first to n^{th} real and imaginary spectra to calculate electrical characteristics of the first to n^{th} layers.

### BRIEF DESCRIPTION OF THE DRAWINGS

Features will become apparent to those of skill in the art by describing in detail exemplary embodiments with reference to the attached drawings in which:

FIG. 1 illustrates an example of a measuring apparatus.

FIG. 2 illustrates an example of a pulse stretcher shown in FIG. 1.

FIG. 3 illustrates an example of an electro-optical device shown in FIG. 1.

FIG. 4 illustrates a pulse of a reference laser beam and a pulse of a terahertz beam shown in FIG. 3.

FIG. 5 illustrates an example of a streak camera shown in FIG. 1.

FIG. 6 illustrates an example of a single-shot image displayed in response to detection signals of FIG. 5.

FIG. 7 illustrates a graph showing an example of a time-domain signal obtained by a controller of a streak camera shown in FIG. 1.

FIG. 8 illustrates a flow chart showing a substrate analysis method.

FIG. 9 illustrates an example of a substrate and a terahertz beam shown in FIG. 1.

FIG. 10 illustrates a flow chart showing an example of obtaining the time-domain signal shown in FIG. 7.

FIGS. 11A and 11B illustrate graphs respectively showing a real spectrum and an imaginary spectrum that are calculated from time-domain signal shown in FIG. 7.

FIGS. 12A and 12B illustrate graphs respectively showing first to third real spectra derived from the real spectrum shown in FIG. 11A and first to third imaginary spectra derived from the imaginary spectrum shown in FIG. 11B.

### DETAILED DESCRIPTION

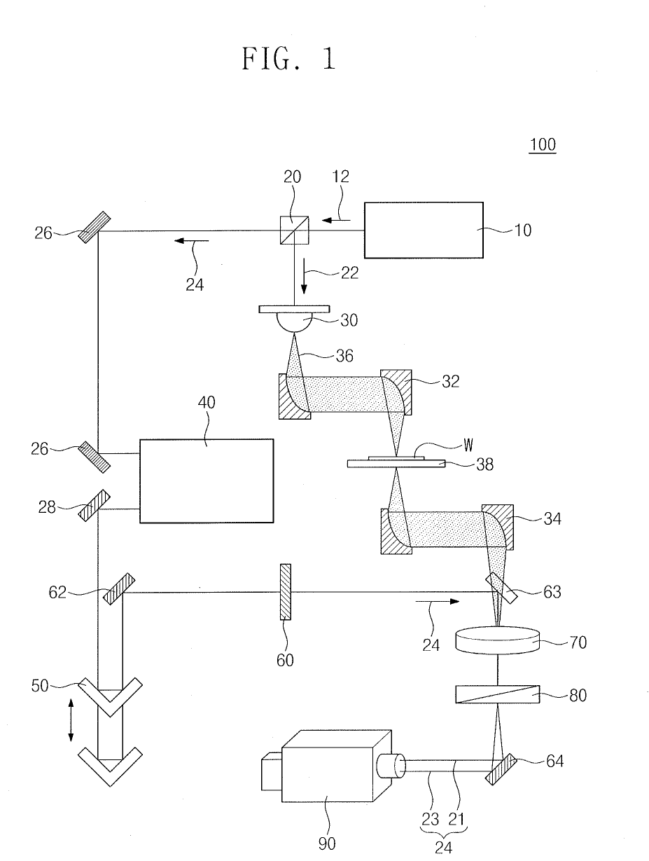

FIG. 1 illustrates an example of a measuring apparatus 100. Referring to FIG. 1, the measuring apparatus 100 may be a femtosecond laser measuring apparatus or a terahertz wave measuring apparatus. For example, the measuring apparatus 100 may include a light source 10, a beam splitter 20, an antenna 30, a pulse stretcher 40, retroreflectors 50, a wave plate 60, an electro-optical device 70, a Wollaston prism 80, and a streak camera 90.

The light source 10 may be a laser. For example, the light source 10 may generate a laser beam 12. The laser beam 12 may be a mode-locked near-infrared femtosecond laser beam, e.g., may have a wavelength of about 800 nm. In an implementation, the laser beam 12 may be a petahertz (PHz) laser beam. In an implementation, the laser beam 12 may have a pulse of about 1 kHZ to about 1 MHz.

The beam splitter 20 may be between the light source 10 and the pulse stretcher 40. For example, the beam splitter 20 may be a half-mirror. The beam splitter 20 may transmit a portion of the laser beam 12 toward the pulse stretcher 40 and may reflect the rest of the laser beam 12 toward the antenna 30. For example, the beam splitter 20 may split the laser beam 12 into a probe laser beam 22 and a reference laser beam 24. The probe laser beam 22 and the reference laser beam 24 may be femtosecond laser beams. The probe laser beam 22 may have the same intensity as that of the reference laser beam 24. The probe laser beam 22 may be provided to the antenna 30 and the reference laser beam 24 may be provided to the pulse stretcher 40.

The antenna 30 may receive the probe laser beam 22 to generate a terahertz beam 36. The terahertz beam 36 may be provided to first collimator mirrors 32. The terahertz beam 36 may have a wavelength of about 0.1 mm to about 1 mm. The terahertz beam 36 may be a picosecond laser beam whose wavelength is longer than that of the reference laser beam 24. The terahertz beam 36 may have a frequency lower than that of the reference laser beam 24, e.g., a longer pulse.

The first collimator mirrors 32 may collimate the terahertz beam 36 onto a substrate W. The first collimator mirrors 32 may include off-axis parabolic mirrors.

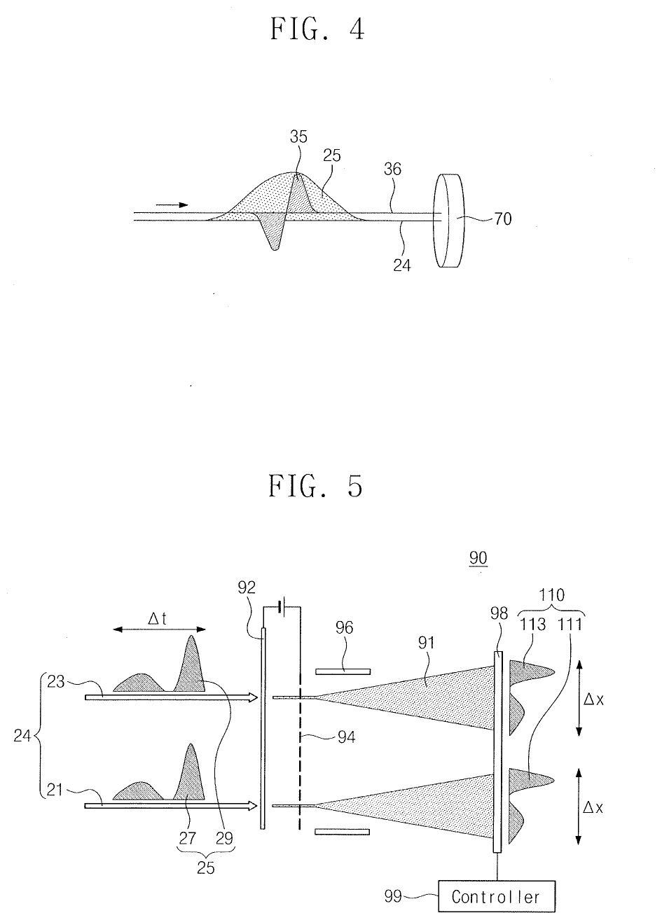

The substrate W may include a silicon wafer. The substrate W may be provided on a stage 38. The substrate W transmits the terahertz beam 36 such that the transmitted terahertz beam 36 has information about the substrate W. For example, the terahertz beam 36 may have a pulse (see 35 of FIG. 4) whose width is changed when transmitted through the substrate W.

The terahertz beam 36 may be provided to second collimator mirrors 34. The second collimator mirrors 34 may collimate the terahertz beam 36 onto the electro-optical device 70. The second collimator mirrors 34 may include off-axis parabolic mirrors.

First mirrors 26 may be between the beam splitter 20 and the pulse stretcher 40 to direct the reference laser beam 24 onto the pulse stretcher 40. The reference laser beam 24 may be provided to the first mirrors 26, which reflect the reference laser beam 24 toward the pulse stretcher 40.

The pulse stretcher 40 may be between the first mirrors 26 and the retroreflectors 50. The pulse stretcher 40 may allow the reference laser beam 24 to have a pulse (see pulse 25 of FIG. 4) whose width is stretched or distributed over time.

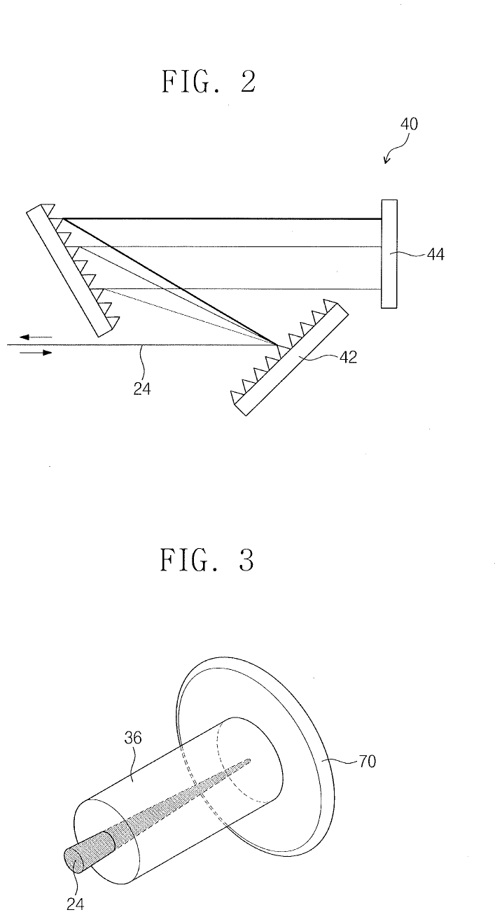

FIG. 2 illustrates an example of the pulse stretcher 40 shown in FIG. 1. Referring to FIG. 2, the pulse stretcher 40 may include a plurality of gratings 42 and a chirped mirror 44. The gratings 42 may face each other. The gratings 42 may diffract the reference laser beam 24. The chirped mirror 44 may be on a rear end of the gratings 42. The chirped mirror 44 may reflect the diffracted reference laser beam 24 back to the gratings 42. The gratings 42 and the chirped mirror 44 may allow the reference laser beam 24 to have a pulse (see pulse 25 of FIG. 4) whose width is stretched or increased in time. For example, the gratings 42 and the chirped mirror 44 may increase the width of the pulse 25 of the reference laser beam 24 by at least twice. The width of the pulse 25 of the reference laser beam 24 may be greater than the width of the pulse 35 of the terahertz beam 36.

Referring back to FIG. 1, a second mirror 28 may be provided between the pulse stretcher 40 and the retroreflectors 50. The second mirror 28 may reflect the reference laser beam 24 output from the pulse stretcher 40 toward the retroreflectors 50.

The retroreflectors 50 may reflect the reference laser beam 24, so that the pulse 25 of the reference laser beam 24 may overlap the pulse 35 of the terahertz beam 36 temporally. The retroreflectors 50 may be on a time-delay stage and a distance between the retroreflectors 50 may be controlled such that the pulse 25 of the reference laser beam 24 to overlap the pulse 35 of the terahertz beam 36. In other words, since the optical path length the terahertz beam 36 travels is longer that than the reference laser beam 24 travels, the retroreflectors 50 lengthen the optical path the reference laser beam 24 to equal that of the terahertz beam 36 so that interference between these beams will be due to changes, e.g., time delay and amplitude, arising from transmission through the substrate W, not due to differences in the optical path lengths therebetween.

A third mirror 62 may be provided between the wave plate 60 and the retroreflectors 50. The third mirror 62 may reflect the reference laser beam 24 output from the retroreflectors 50 toward the wave plate 60.

The wave plate 60 may be between the electro-optical device 70 and the retroreflectors 50. The wave plate 60 may change a polarization state of the reference laser beam 24. For example, the wave plate 60 may be a quarter-wave (λ/4) plate. When the reference laser beam 24 passes through the wave plate 60, a polarization direction of the reference laser beam 24 may be changed by π/2. The wave plate 60 may produce a vertical polarization component 21 and a horizontal polarization component 23 of the reference laser beam 24. The wave plate 60 may provide the reference laser beam 24 to a fourth mirror 63 which will be discussed below. Alternatively, the wave plate 60 may be a half-wave (λ/2) plate.

A fourth mirror 63 may be provided between the wave plate 60 and the electro-optical device 70. For example, the fourth mirror 63 may be a half-mirror. The fourth mirror 63 may cause the reference laser beam 24 to have a propagation direction the same as that of the terahertz beam 36. The fourth mirror 63 may reflect the reference laser beam 24 toward the electro-optical device 70. The fourth mirror 63 may be between the second collimator mirrors 34 and the electro-optical device 70. The fourth mirror 63 may transmit the terahertz beam 36 toward the electro-optical device 70.

FIG. 3 illustrates an example of the electro-optical device 70 shown in FIG. 1. Referring to FIGS. 1 and 3, the electro-optical device 70 may be between the wave plate 60 and the Wollaston prism 80. The electro-optical device 70 may receive the reference laser beam 24 and the terahertz beam 36. For example, the reference laser beam 24 may have a beam size, e.g., a beam diameter, less than that of the terahertz beam 36.

FIG. 4 illustrates the pulse 25 of the reference laser beam 24 and the pulse 35 of the terahertz beam 36. Referring to FIG. 4, the pulse 25 of the reference laser beam 24 and the pulse 35 of the terahertz beam 36 may overlap each other in time and/or space. The pulse 25 of the reference laser beam 24 may have a width greater than that of the pulse 35 of the terahertz beam 36. For example, the width of the pulse 25 of the reference laser beam 24 may be greater than at least twice the width of the pulse 35 of the terahertz beam 36.

The electro-optical device 70 may include ZnTe, GaP, LiNbO₃, or GaSe. The electro-optical device 70 may use the optical Kerr effect to create interference between the pulse 25 of the reference laser beam 24 and the pulse 35 of the terahertz beam 36. The pulse 35 of the terahertz beam 36 may induce an optical Kerr gating of the electro-optical device 70 to change a ratio between the vertical polarization component 21 and the horizontal polarization component 23 of the reference laser beam 24. For example, based on an intensity of the terahertz beam 36, the electro-optical device 70 may change the ratio between the vertical polarization component 21 and the horizontal polarization component 23 of the reference laser beam 24. For another example, based on the pulse 35 of the terahertz beam 36, the electro-optical device 70 may change the ratio between the vertical polarization component 21 and the horizontal polarization component 23 of the reference laser beam 24. When the terahertz beam 36 decreases in intensity, the ratio between the vertical polarization component 21 and the horizontal polarization component 23 of the reference laser beam 24 may become equal, e.g., one-to-one ratio. When the terahertz beam 36 increases in intensity, the vertical polarization component 21 may become larger than the horizontal polarization component 23 or the horizontal polarization component 23 may become larger than the vertical polarization component 21.

Referring back to FIG. 1, the Wollaston prism 80 may be between the electro-optical device 70 and the streak camera 90. The Wollaston prism 80 may receive the reference laser beam 24 to separate the vertical polarization component 21 and the horizontal polarization component 23 from each other.

A fifth mirror 64 may be provided between the Wollaston prism 80 and the streak camera 90. The fifth mirror 64 may reflect the vertical polarization component 21 and the horizontal polarization component 23 toward the streak camera 90.

The streak camera 90 may detect the vertical polarization component 21 and the horizontal polarization component 23. The streak camera 90 may measure a variation in intensity of the reference laser beam 24 with respect to a portion of the substrate W through which the terahertz beam 36 has passed. For example, the streak camera 90 may detect the ratio between the vertical polarization component 21 and the horizontal polarization component 23 of the reference laser beam 24.

FIG. 5 illustrates an example of the streak camera 90 shown in FIG. 1. Referring to FIG. 5, the streak camera 90 may include a photocathode 92, an anode mesh 94, a timing slit 96, an imaging device 98, and a controller 99.

The photocathode 92 may receive the vertical polarization component 21 and the horizontal polarization component 23 of the reference laser beam 24. The photocathode 92 may create photoelectrons 91 by using photoelectric effects of the vertical and horizontal polarization components 21 and 23. The number of the photoelectrons 91 may be proportional to magnitude or intensity of a pulse 27 of the vertical polarization component 21 and of a pulse 29 of the horizontal polarization component 23.

The anode mesh 94 may be between the photocathode 92 and the timing slit 96. The anode mesh 94 may accelerate the photoelectrons 91 toward the timing slit 96.

The timing slit 96 may be between the anode mesh 94 and the imaging device 98. The timing slit 96 may deflect the accelerated photoelectrons 91 over time. The timing slit 96 may sweep the photoelectrons 91 on the imaging device 98. A time delay Δt or time variation of the photoelectrons 91 during sweeping may be recorded as a spatial difference Δx in the imaging device 98.

The imaging device 98 may detect the photoelectrons 91 to obtain detection signals 110 to be output to the controller 99. The detection signals 110 may be signals in time domain (also referred to hereinafter as time-domain signals) of the vertical and horizontal polarization components 21 and 23, which time-domain signal may vary with the time delay Δt of the reference laser beam 24. Alternatively, the detection signals 110 may be time-domain signals of the pulses 27 and 29 of the vertical and horizontal polarization components 21 and 23. For example, the detection signals 110 may include a first detection signal 111 and a second detection signal 113. The first detection signal 111 may be obtained from the pulse 27 of the vertical polarization component 21. The second detection signal 113 may be obtained from the pulse 29 of the horizontal polarization component 23.

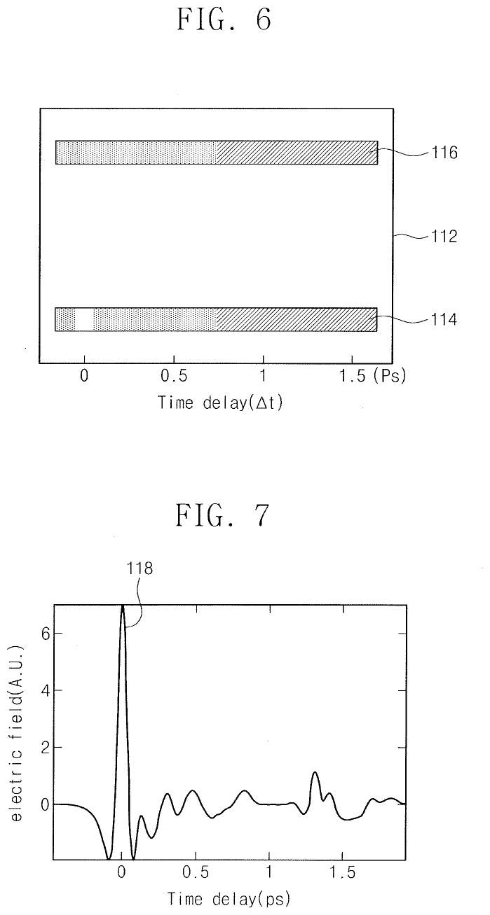

FIG. 6 illustrates an example of a single-shot image 112 displayed in response to the detection signals 110 shown in FIG. 5. Referring to FIG. 6, the first detection signal 111 and the second detection signal 113 may form the single-shot image 112. Thus, without scanning a time difference (or a time delay) between the pulse 35 of the terahertz beam 36 and the pulse 25 of the reference laser beam 24, the streak camera 90 may obtain the single-shot image 112 in response to the first and second detection signals 111 and 113, which may reduce time required for measuring and/or inspecting the substrate W.

For example, the single-shot image 112 may include a vertical polarization image 114 and a horizontal polarization image 116. The vertical and horizontal polarization images 114 and 116 may be linear in the single-shot image 112. The vertical polarization image 114 may be obtained from the first detection signal 111 of the vertical polarization component 21 and the horizontal polarization image 116 may be obtained from the second detection signal 113 of the horizontal polarization component 23.

FIG. 7 illustrates an example of a time-domain signal 118 obtained by the controller 99 of the streak camera 90 shown in FIG. 5. Referring to FIG. 7, the controller 99 of the streak camera 90 may obtain the time-domain signal 118 corresponding to a ratio between the first detection signal 111 and the second detection signal 113. The time-domain signal 118 may be expressed as electric field intensity (or electric field amplitude) at a time lapse of about 2 picoseconds. In an implementation, the time-domain signal 118 may be expressed as electric field intensity at a time lapse of about 10 picoseconds to about 100 picoseconds. The time-domain signal 118 may correspond to the ratio between the vertical polarization component 21 and the horizontal polarization component 23 of the reference laser beam 24 that depends on the time delay Δt of the reference laser beam 24. In an implementation, the time-domain signal 118 may correspond to a ratio between the pulse 27 of the vertical polarization component 21 and the pulse 29 of the horizontal polarization component 23.

The controller 99 of the streak camera 90 may use the time-domain signal 118 to analyze electrical characteristics of the substrate W. The electrical characteristics may include resistance, refractive index, and charge-carrier trap sites. The following will describe a method of analyzing the substrate W using the time-domain signal 118.

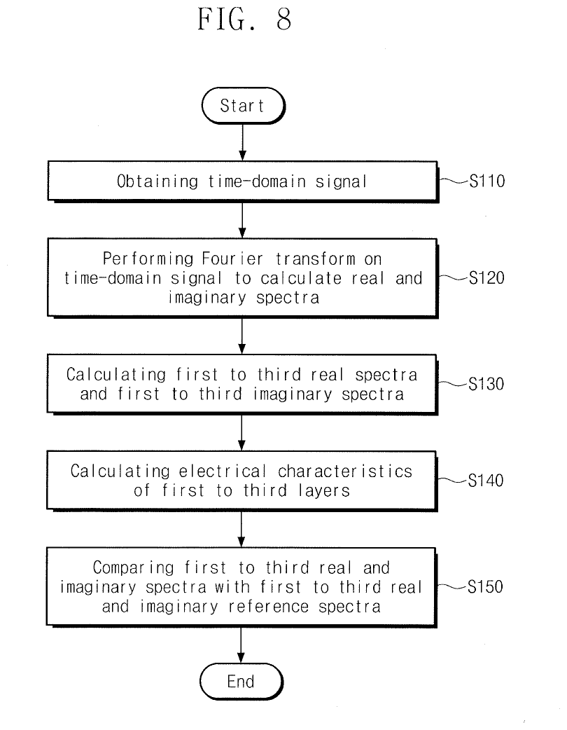

FIG. 8 illustrates the method of analyzing the substrate W shown in FIG. 1. Referring to FIG. 8, the method of analyzing the substrate W may include obtaining the time-domain signal 118 (S110), performing a Fourier transform on the time-domain signal 118 to calculate real and imaginary spectra (S120), analyzing the real and imaginary spectra to obtain first to third real and imaginary spectra (S130), calculating first to third electrical characteristics of first to third layers (S140), and comparing first to third real and imaginary spectra with first to third real and imaginary reference spectra (S150).

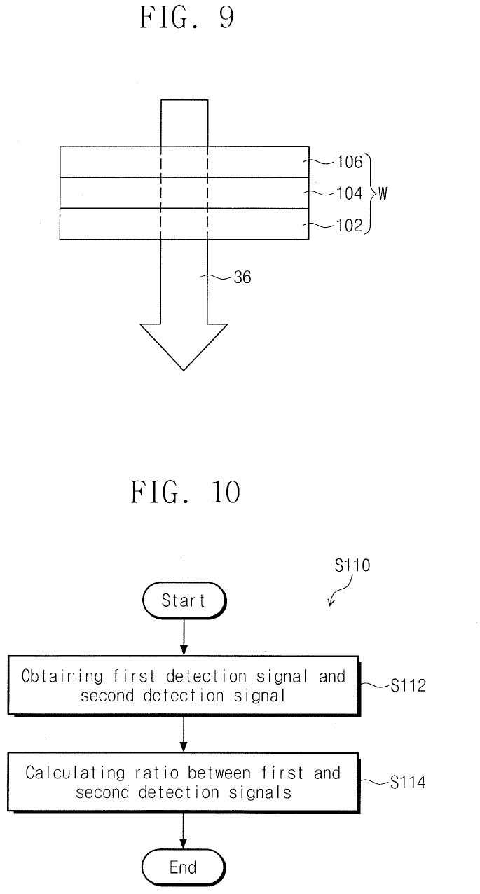

FIG. 9 illustrates an example of the substrate W and the terahertz beam 36 shown in FIG. 1. Referring to FIGS. 1, 8, and 9, when the terahertz beam 36 is transmitted through the substrate W and directed in the same direction as that of the reference laser beam 24, the controller 99 of the streak camera 90 may obtain the time-domain signal 118 at a related location on the substrate W (S110). For example, the substrate W may include first, second, and third layers 102, 104, and 106. The first layer 102 may be a silicon wafer, the second layer 104 may be a conductive layer, and the third layer 106 may be a dielectric layer. In an implementation, the substrate W may include first to n^{th} layers (hereinafter, n is an integer equal to or greater than 4).

FIG. 10 illustrates an example of obtaining the time-domain signal 118 (S110) shown in FIG. 7. Referring to FIG. 10, obtaining the time-domain signal 118 (S110) may include obtaining the first detection signal 111 and the second detection signal 113 (S112), and calculating the ratio between the first detection signal 111 and the second detection signal 113 (S114).

Referring to FIGS. 5, 6, and 10, the controller 99 of the streak camera 90 may obtain the first detection signal 111 and the second detection signal 113 from the imaging device 98 (S112). The first detection signal 111 and the second detection signal 113 may appear as the vertical polarization image 114 and the horizontal polarization image 116 on the image 112.

The controller 99 may calculate the ratio between the first detection signal 111 and the second detection signal 113 to obtain the time-domain signal 118 (S114). The ratio between the first detection signal 111 and the second detection signal 113 may be calculated based on the time delay Δt of the terahertz beam 36.

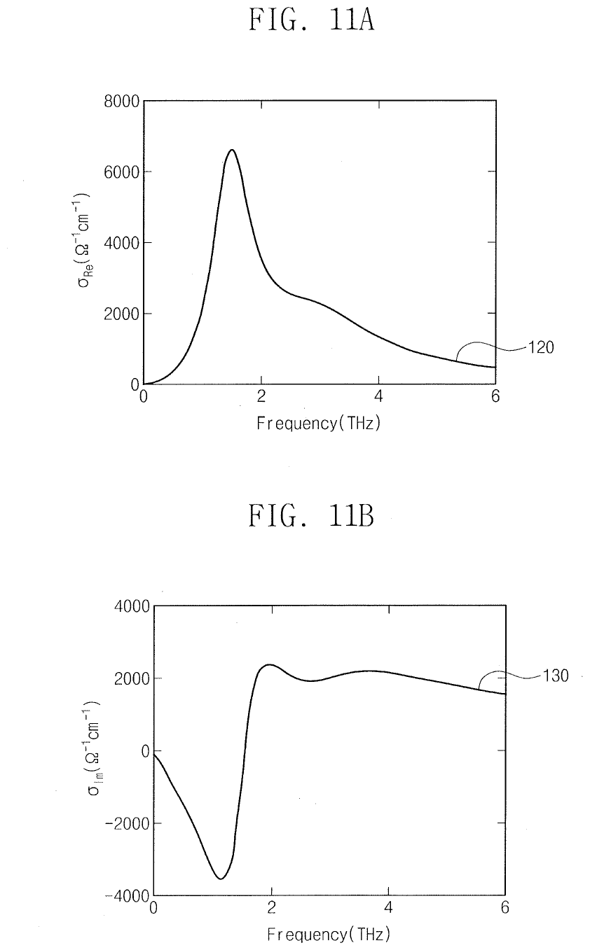

FIGS. 11A and 11B respectively illustrate a real spectrum 120 and an imaginary spectrum 130 calculated from the time-domain signal 118 shown in FIG. 7. Referring to FIGS. 9, 11A, and 11B, the controller 99 may perform a Fourier transform on the time-domain signal 118 to calculate the real spectrum 120 and the imaginary spectrum 130 (S120). Each of the real spectrum 120 and the imaginary spectrum 130 may be expressed as electrical conductivity at a frequency ranging from about 0 to about 6 THz.

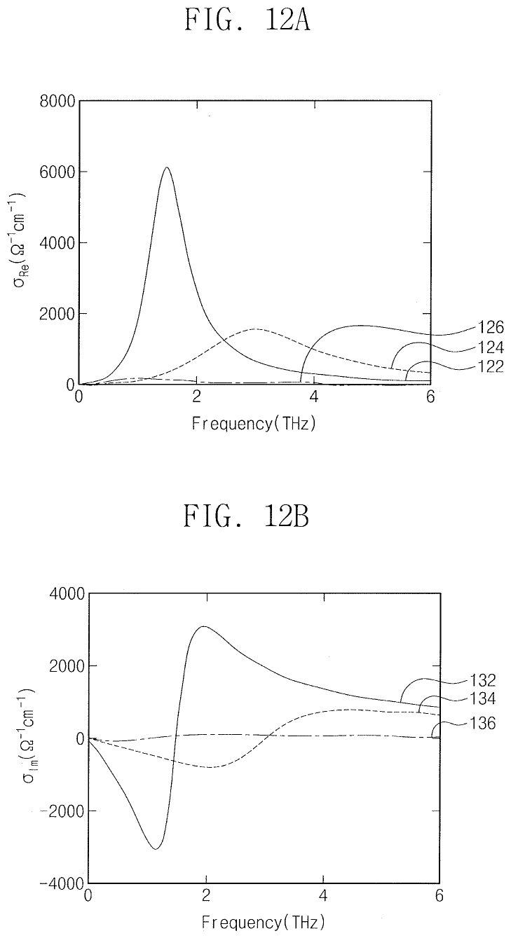

FIG. 12A illustrates first, second, and third real spectra 122, 124, and 126 derived from the real spectrum 120 shown in FIG. 11A, and FIG. 12B illustrates first, second, and third imaginary spectra 132, 134, and 136 derived from the imaginary spectrum 130 shown in FIG. 11B.

Referring to FIGS. 8, 12A, and 12B, the controller 99 may analyze the real spectrum 120 and the imaginary spectrum 130 to obtain the first, second, and third real spectra 122, 124, and 126, and to obtain the first, second, and third imaginary spectra 132, 134, and 136 of the first, second, and third layers 102, 104, and 106 (S130), respectively. When the substrate W includes first to n^{th} layers, the controller 99 may obtain first to n^{th} real spectra and first to n^{th} imaginary spectra. Each of the first to third real and imaginary spectra 122, 132, 124, 134, 126, and 136 may be expressed as electrical conductivity at a frequency ranging from about 0 to 6 THz.

In certain embodiments, global analysis may be employed to analyze the real spectrum 120 and the imaginary spectrum 130. For example, the first to third real and imaginary spectra 122, 132, 124, 134, 126, and 136 may be calculated by linear combinations of pre-stored basis set values and the real and imaginary spectra 120 and 130. The basis set values may be calculated in advance by a modeling method performed on each of the first, second, and third layers 102, 104, and 106, and then stored in a data base. The modeling method may include a plasmon model (e.g., an expanded type of Drude-Lorentz model). Additionally, or alternatively, the first to third real and imaginary spectra 122, 132, 124, 134, 126, and 136 may be calculated through least square optimization of the real spectrum 120 and the imaginary spectrum 130. The least square optimization may be performed such that parameters of the modeling method shared by the real spectrum 120 and the imaginary spectrum 130 are fit the first to third real and imaginary spectra 122, 132, 124, 134, 126, and 136. The least square optimization may reduce correlation between components of the first, second, and third layers 102, 104, and 106, and also decrease an over-fitting.

The controller 99 may use the first to third real and imaginary spectra 122, 132, 124, 134, 126, and 136 to calculate electrical characteristics of the first, second, and third layers 102, 104, and 106 (S140). When the substrate W includes first to n^{th} layers, the controller may use the first to n^{th} real and imaginary spectra to calculate electrical characteristics of the first to n^{th} layers. When the first to third real and imaginary spectra 122 to 136 are expressed as conductivities at terahertz frequencies, the controller 99 may consider absolute values of the first to third real and imaginary spectra 122 to 136 as conductivities of the first, second, and third layers 102, 104, and 106. The controller 99 may consider reciprocals of the conductivities as resistivities of the first, second, and third layers 102, 104, and 106. The controller 99 may use the resistivities to calculate thicknesses and areas of the first, second, and third layers 102, 104, and 106.

The controller 99 may compare the first to third real and imaginary spectra 122 to 136 with pre-stored first to third real and imaginary reference spectra to determine whether or not the substrate W has a defect (S150). The controller 99 may determine that the substrate W has no defect when there is coherence, within an allowable error range, between the first to third real reference spectra and their corresponding first to third real spectra 122, 124, and 126, and between the first to third imaginary reference spectra and their corresponding first to third imaginary spectra 132, 134, and 136. The controller 99 may determine that the substrate W has a defect when there is no coherence between the first to third real reference spectra and their corresponding first to third real spectra 122, 124, and 126 or between the first to third imaginary reference spectra and their corresponding first to third imaginary spectra 132, 134, and 136. In an implementation, the controller 99 may compare pre-stored reference characteristics with electrical characteristics of the first, second, and third layers 102, 104, and 106 to determine whether or not the first, second, and third layers 102, 104, and 106 have their defects.

The stage 38 may move the substrate W and the measuring apparatus 100 may analyze the substrate W by providing the terahertz beam 36 to other locations on the substrate W. The measuring apparatus 100 may perform operations S110 to S150 to determine whether or not the substrate W has a defect on the other location.

According to one or more embodiments, a measuring apparatus may include a streak camera to obtain a single-shot image in response to first and second detection signals of vertical and horizontal polarization components of a reference laser beam that depend on intensity of a terahertz beam, and as a result may reduce a measurement time and/or an inspection time.

Embodiments are described, and illustrated in the drawings, in terms of functional blocks, controllers, and/or methods. Those skilled in the art will appreciate that these blocks, controllers, and/or methods are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, controllers, and/or methods being implemented by microprocessors or similar, they may be programmed using software (e.g., microcode) to perform various functions discussed herein and may optionally be driven by firmware and/or software. Alternatively, each block, controller, and/or method may be implemented by dedicated hardware, or as a combination of dedicated hardware to perform some functions and a processor (e.g., one or more programmed microprocessors and associated circuitry) to perform other functions. Also, each block and/or controller of the embodiments may be physically separated into two or more interacting and discrete blocks and/or controllers without departing from the scope of the disclosure. Further, the blocks and/or controllers of the embodiments may be physically combined into more complex blocks and/or controllers without departing from the scope of the disclosure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A measuring apparatus, comprising:
a light source that generates a laser beam;
a beam splitter that splits the laser beam into a probe laser beam and a reference laser beam;
an antenna that receives the probe laser beam to produce a terahertz beam;
an electro-optical device that receives the reference laser beam and the terahertz beam and changes a vertical polarization component and a horizontal polarization component of the reference laser beam based on the terahertz beam; and
a streak camera that obtains a time-domain signal corresponding to a ratio between the vertical polarization component and the horizontal polarization component.

2. The measuring apparatus as claimed in claim 1, wherein the reference laser beam has a beam diameter smaller than that of the terahertz beam.

3. The measuring apparatus as claimed in claim 1, further comprising a pulse stretcher between the beam splitter and the electro-optical device, the pulse stretcher temporally stretching a pulse width of the reference laser beam.

4. The measuring apparatus as claimed in claim 3, further comprising a retroreflector between the pulse stretcher and the electro-optical device, wherein the retroreflector temporally overlaps a pulse of the reference laser beam and a pulse of the terahertz beam.

5. The measuring apparatus as claimed in claim 4, further comprising a wave plate between the retroreflector and the electro-optical device, the wave plate to output the vertical polarization component and the horizontal polarization component of the reference laser beam.

6. The measuring apparatus as claimed in claim 1, further comprising a Wollaston prism between the electro-optical device and the streak camera, the Wollaston prism separating the vertical polarization component and the horizontal polarization component from each other.

7. The measuring apparatus as claimed in claim 1, further comprising:
a plurality of first collimator mirrors between the antenna and a substrate, the plurality of first collimator mirrors directing the terahertz beam from the antenna onto the substrate; and
a plurality of second collimator mirrors between the substrate and the electro-optical device, the plurality of second collimator mirrors directing the terahertz beam from the substrate onto the electro-optical device.

8. The measuring apparatus as claimed in claim 7, further comprising a mirror between the electro-optical device and the plurality of second collimator mirrors, the mirror transmitting the terahertz beam toward the electro-optical device and reflecting the reference laser beam toward the electro-optical device.

9. The measuring apparatus as claimed in claim 7, further comprising a stage between the plurality of first collimator mirrors and the plurality of second collimator mirrors, the stage receiving the substrate.

10. The measuring apparatus as claimed in claim 1, wherein
the reference laser beam is a femtosecond laser beam, and
the terahertz beam is a picosecond laser beam having a longer wavelength than the femtosecond laser beam.

11. A measuring apparatus, comprising:
a light source that generates a laser beam having a first pulse;
a beam splitter that splits the laser beam into a probe laser beam and a reference laser beam;
an antenna that receives the probe laser beam to produce a terahertz beam and provides a target object with the terahertz beam to generate a second pulse different from the first pulse;
a pulse stretcher that stretches a width of the first pulse of the reference laser beam;
a wave plate that receives the reference laser beam to create a vertical polarization component and a horizontal polarization component of the reference laser beam;
an electro-optical device that receives the reference laser beam and the terahertz beam to change a pulse of the vertical polarization component and a pulse of the horizontal polarization component based on the second pulse of the terahertz beam; and
a streak camera that detects the vertical polarization component and the horizontal polarization component to obtain a time-domain signal corresponding to a ratio between the pulse of the vertical polarization component and the pulse of the horizontal polarization component.

12. The measuring apparatus as claimed in claim 11, wherein the reference laser beam is a petahertz beam whose frequency is higher than a frequency of the terahertz beam.

13. The measuring apparatus as claimed in claim 11, wherein the pulse stretcher includes:
a plurality of gratings that diffract the reference laser beam; and
a chirped mirror that reflects the diffracted reference laser beam toward the gratings.

14. The measuring apparatus as claimed in claim 11, wherein the streak camera includes:
a photocathode that receives the reference laser beam to generate a photoelectron;
an anode mesh that accelerates the photoelectron;
a timing slit that deflects the accelerated photoelectron over time; and
an imaging device that detects the deflected photoelectron to obtain the time-domain signal.

15. The measuring apparatus as claimed in claim 11, wherein the wave plate includes a quarter-wave plate.

16. A substrate analysis method, comprising:
obtaining a time-domain signal using a terahertz beam transmitted from a substrate and a femtosecond laser beam that temporally and spatially overlaps the terahertz beam;
performing a Fourier transform on the time-domain signal to calculate real and imaginary spectra;
analyzing the real and imaginary spectra to obtain first to n^{th} real and imaginary spectra of first to n^{th} layers included in the substrate; and
using the first to n^{th} real and imaginary spectra to calculate electrical characteristics of the first to n^{th} layers.

17. The substrate analysis method as claimed in claim 16, wherein obtaining the time-domain signal includes:
obtaining first and second detection signals by using a vertical polarization and a horizontal polarization of the femtosecond laser beam, the vertical and horizontal polarization components being changed based on intensity of the terahertz beam; and
calculating a ratio between the first and second detection signals, based on a time delay of the terahertz beam, to obtain the time-domain signal.

18. The substrate analysis method as claimed in claim 16, further comprising comparing the first to n^{th} real and imaginary spectra with first to n^{th} real and imaginary reference spectra to determine whether or not the substrate has a defect.

19. The substrate analysis method as claimed in claim 16, wherein the real and imaginary spectra are expressed as electrical conductivity at a terahertz frequency.

20. The substrate analysis method as claimed in claim 16, wherein the first to n^{th} real and imaginary spectra are calculated through least square optimization of the real and imaginary spectra.
